(19) United States
(12) Patent Application Publication
(10) Pub. No.: US 2017/0307906 A1
(43) Pub. Date: Oct. 26, 2017

(54) ELECTRONIC SOLAR AND LASER BLOCKING SUNGLASSES

(71) Applicants: Alfred David Goldsmith, Irvine, CA (US); David G. Pelka, Los Angeles, CA (US)

(72) Inventors: Alfred David Goldsmith, Irvine, CA (US); David G. Pelka, Los Angeles, CA (US)

(21) Appl. No.: 15/498,207

(22) Filed: Apr. 26, 2017

Related U.S. Application Data
(60) Provisional application No. 62/327,966, filed on Apr. 26, 2016.

(51) Int. Cl. G02C 7/10; G02F 1/133

(52) U.S. Cl. CPC G02C 7/101; G02C 7/105; G02F 1/13318; G02C 7/104; G02F 2001/13324; G02C 2202/18

(57) ABSTRACT

A sunglass using a transparent, pixelated, liquid crystal (LC) two-dimensional array, or functionally equivalent technology, in possible combination with optical materials to selectively attenuate or block the Sun or its reflection from the field of view (FOV) of the person wearing the glasses is disclosed. An imaging camera located within the sunglasses detects the Sun, with software determining its position via centroiding algorithms. The Solar position is then translated, and, if necessary, rotated, scaled and skewed for the appropriate pixels in the left and right lens of the sunglass, where left eye and right eye “circles” are created to block or attenuate the Sun's image from the person wearing the glasses. Additionally, the sunglass lens will have protection against the Sun's ultra-violet (UV) rays. The internal power source may be either replaceable, or charged by solar or standard methods.

### RELATED APPLICATION INFORMATION

The present application claims priority under 35 U.S.C. Section 119(e) to U.S. Provisional Patent Application Ser. No. 62/327,966 filed Apr. 26, 2016 entitled “ELECTRONIC SOLAR AND LASER BLOCKING SUNGLASSES” the disclosure of which is incorporated herein by reference in its entirety.

### BACKGROUND

### 1. Field

The present application relates in general to protective eyewear. More particularly, the present application is directed to electronically-controlled eyewear for selectively blocking regions of intense light from a wearer's field of view.

### 2. Description of the Related Art

Sunglasses of all types are commercially available for reasonably low costs. The main distinction between the different types and brands are either based on the attenuation principle used or simply cosmetic differences. Specifically, attenuation can be achieved by a combination of polarization, reflection and/or absorption. Cosmetic differences can include the size, shape and general design of the sunglasses. Examples of these differences can be seen in, for example, U.S. Pat. D307283, D320802, D294953, D357268, although many more examples are available. The function that these sunglasses have in common is that all the light passing through is subject to the same attenuation, including sources that may be dim or within the eye's normal response.

Several devices may utilize active technology to adjust the throughput of the sunglasses as a function of the ambient brightness. The device(s) uses an optical detector to sense the ambient light; the output of the detector is then sent to a liquid crystal that adjusts the optical throughput of the sunglasses. It is important to note that this device(s) adjusts the transmission of the total active area of the sunglasses and does not specifically block the rays from the interfering light source. Other sunglasses may use a RGB sensor to change the hue of liquid crystal lenses, and, again, does not specifically block the solar image or laser source. While not sunglasses, specialized goggles do have advanced functionality. As an example, eye protection goggles can be purchased for people who work with lasers or engage in welding. Various websites advertise these products. Again, although these goggles can in principle use active technology; if electronics are present, they may only control the total transmission. These products may work by providing an extreme attenuation of the light rays emitted by the optical source under question. If used as normal sunglasses they would severely limit the amount of normal ambient light that passes to the eye.

Accordingly, a need exists to improve the functionality of sunglasses.

### SUMMARY

In the first aspect, protective gear for a user's eyes for selectively blocking one or more regions of intense light from a field of view of the user is disclosed. The protective gear comprises a lens configured to be positioned in front of the user's eye in the field of view of the user. The lens has a two dimensional array of electrically controllable, variable transparency elements, and at least one photosensor located in proximity to the lens. The photosensor monitors the images entering the field of view of the user and provides an electrical image signal. The protective gear further comprises a controller coupled to the lens and the photosensor. The controller receives the electrical image signal from the photosensor and determines the one or more regions of intense light within the field of view of the user. The controller maps the one or more regions of intense light received by the photosensor to the corresponding set of elements on the lens receiving the one or more regions of intense light. The controller selectively attenuates the transparency of the corresponding set of elements on the lens receiving the one or more regions of intense light.

In a first preferred embodiment, the protective gear further comprises a solar cell charging a battery connected to the protective gear for powering the protective eye gear. The protective gear preferably further comprises a battery connected to the protective gear for powering the protective gear. The two dimensional array of electrically controllable, variable transparency elements may preferably block the intense light by forming geometrical shapes to cover the regions of intense light. The controller preferably thresholds and centroids the regions of intense light and translates the coordinates to the lens to attenuate the associated elements. The two dimensional array of electrically controllable, variable transparency elements preferably comprises a liquid crystal display matrix. The two dimensional array of electrically controllable, variable transparency elements preferably comprises an active matrix liquid crystal display. The remaining field of view outside the attenuated elements on the lens preferably remains clear or uniformly attenuated. The photosensor is preferably a camera. The photosensor is preferably a charge coupled device (“CCD”) camera. The photosensor is preferably a complementary metal-oxide-semiconductor (“CMOS”) device. The protective eye gear is preferably configured to appear as conventional two-lenses sunglasses.

In a second aspect, a method for selectively blocking localized regions of light from a field of view in a protective eye gear comprising a lens having a two dimensional array of electronically controllable, variable transparency elements, a photosensor, and a controller is disclosed. The method comprises monitoring a field of view of a user, determining one or more regions of intense light within the field of view, mapping the regions of intense light to specific electronically-controllable variable transparent elements receiving the regions of intense light in the field of view of the user, and selectively attenuating the transparency of the specific elements positioned in the regions of intense light.

In a second preferred embodiment, the method further comprises setting a centroiding region for a full camera output by calculating a rough Center of Mass for the regions of intense light. The method preferably further comprises setting a region of interest (“ROI”) slightly larger than the dimension of the region of intense light. The method preferably further comprises calculating the center of mass within the region of interest. The method preferably further comprises changing the coordinates of the region of intense light to the two-dimensional array of elements. The method preferably further comprises generating a circular spot within the two-dimensional electronically-controllable variable transparent array that is sufficiently large to block the regions of intense light. The method preferably further comprises updating the position of the regions of intense light as the region of intense light moves in the field of view.

In a third aspect, protective eye gear for selectively blocking localized regions of intense light from a field of view is disclosed. The eye gear comprises a lens configured to be positioned in front of a user's eye to form a field of view for the user. The lens has a two dimensional array of electronically controllable, variable transparency liquid crystal display elements, and at least one camera located in proximity to the lens. The camera monitors the images entering the field of view of the user and provides an electrical image signal. The eye gear further comprises a controller coupled to the lens and the camera. The controller receives the image signal from the camera and determines one or more regions of intense light within the field of view of the user. The controller maps the regions of intense light received by the camera to the corresponding set of liquid crystal display elements on the lens receiving the intense light. The controller selectively attenuates the transparency of the corresponding set of liquid crystal display elements on the lens receiving the intense light.

In a third preferred embodiment, the two dimensional array of electronically-controllable variable transparent elements may block the intense light by forming geometrical shapes to cover the regions of intense light. The controller preferably thresholds and centroids the regions of intense light and translates the coordinates to the lens to attenuate the associated elements.

In a fourth preferred embodiment, the above listed functions may be accomplished via centroiding and whole image translation/rotation/scaling/skewing to the eyeglass coordinates. This procedure is functionally equivalent to the other stated methodologies, albeit slower.

These and other features and advantages of the preferred embodiments will become more apparent with a description of preferred embodiments in reference to the associated drawings.

### DESCRIPTION OF THE DRAWINGS

The above and other aspects, features and advantages of the preferred embodiments will be apparent from the following more particular description thereof, presented in conjunction with the following drawings and tables wherein:

FIG. 1 is a schematic, block diagram of electronic sunglasses in one or more embodiments.

FIG. 2 illustrates a generic illustration of the Electronic Solar and Laser Blocking Sunglasses (“ESOLAB”) glasses in an embodiment.

FIG. 3 is a functional schematic diagram and general illustration of the ESOLAB glasses in an embodiment.

FIG. 4 is a representative plot of the transmission as a function of voltage for a Super Twisted Nematic Display.

FIG. 5 is a flowchart illustrating a process for locating and tracking regions of intense light in a user's field of view.

FIG. 6 shows an illustration of the input image for a simulation.

FIG. 7 illustrates the centoiding and region of interest (ROI).

FIG. 8 is an illustration based on the software model's outputs of the masked Sun for solar mask efficiency of 70%.

FIG. 9 is an illustration based on the software model's outputs of the masked Sun for solar mask efficiency of 100%.

FIG. 10 is a functional flow of the hardware Interface program illustrating the actual components used for the proof of concept.

FIG. 11 is the basic configuration of the hardware interface program for the demonstration.

### DETAILED DESCRIPTION OF THE PREFERRED EMBODIMENTS

There are many occasions in which glare from intense light sources that are much brighter than the surrounding objects can cause discomfort or even create unsafe conditions. This may occur when an automobile driver heads westward at sunset for example. One or more embodiments are directed to protective eyewear such as sunglasses that automatically block regions of intense light from entering the eye of the wearer while allowing the wearer to see the remaining objects in his field of view. The electronic sunglasses may comprise a lens, a camera, and a controller, and may be fashioned to appear as conventional sunglasses. The lenses of sunglasses are configured to selectively block regions of intense light from entering the eye of the wearer. In one or more embodiments, a camera attached to the sunglasses monitors the images that are entering the eye of the wearer and sends the image information to a controller. The controller determines if regions of the image are excessively bright, and will selectively block the bright light from entering the eye of the wearer while allowing the user to see the remaining field of view unobstructed. This would eliminate blinding at night by oncoming cars, where the surrounding field of view of the lens would be clear in one or more embodiments.

One or more embodiments may comprise a new type of sunglass that would actively sense extremely bright sources such as the Sun or a laser and block or significantly reduce only that part of the scene wherein the source is located. Use of such sunglasses would provide, in addition to the normal eye protection, blockage of any object (such as the Sun or a laser) that is within the eye's Field of View (“FOV”). All other objects would still be visible at the same or similar attenuation that was present before the interfering object was in the eye's FOV. Because of the electronic nature of this system, it is also possible to develop sunglasses where the transmission of the regions adjacent to the interfering source could be modified if or as needed. And so, the development of a new type of active sunglass with the safety aspects that eliminates temporary or permanent blinding from high output optical sources will be achieved in the following disclosure.

One or more embodiments articulate the development of active sunglasses that block any bright light source while having either no effect or a minor effect on the surrounding image passing through the glasses. Applications include, but are not limited to, blockage of the Sun's image or blockage of a laser beam intercepting part of the active area of the sunglasses.

Hence, one or more embodiments offer important functionality and benefits to the user. One or more embodiments offer a unique development of light-blocking/light attenuating sunglasses or visors that can selectively block or attenuate bright light sources without the need to change the overall attenuation of the sunglasses or visors. In addition to blocking/attenuating the bright light source, embodiments of the sunglasses or visors may also adjust the attenuation of the remaining sunglass/visor areas. The remaining sunglass/visor areas need not have the same transmission as the area with the bright light source. In an embodiment, the bright source can be blocked or attenuated by any geometric shape sufficiently large enough to cover the image: this includes circular or elliptical disks, squares, rectangles, etc., unlike conventional electronic sunglass technology that changes either the transmission or tint of the whole lens and is not selective.

The blocked light source would include the Sun, lasers, explosions and any bright event. One or more embodiments employ a blocking method that is unique in that it thresholds and centroids the bright object, finding its 2-D coordinates. It then translates (and rotates, skews and/or scales, if necessary) the coordinates to the sunglass lens's positions creating blocking/attenuating spots at each lens. Thus it avoids image translation/rotation/skewing/scaling, significantly increasing response time. The detecting array is not limited to CCD or CMOS technology, especially as technology develops. One possible example would be use of a microbolometer focal plane array.

Moreover, the waveband is not limited to the visible. With appropriate changes of optical materials and sensors the optical range extends from the UV through the very long wavelength infrared (“VLWIR”). The lens material is not limited to plastics; any other material, such as glass, that can perform the same function may be utilized.

One or more embodiments employ a transparent TFT LCD (thin-film-transistor liquid-crystal display). This technology was chosen for it his contrast capability. To further improve its performance for this task and enhance its clarity, the following modifications to the technology are contemplated such as by increasing the pixel size, leaving more room for the transistor driver on each pixel and improving clarity. As validation, a test was performed on a working non-TFT LCD without a backlight or reflector and it was crystal clear. Hence, this result validates that larger monochrome pixels will solve the issue. The Sun, for example subtends a 0.53° full angle at the Earth, so angular resolutions about 0.1° would be quite acceptable.

Another enhancement to the system performance involves the optical liquid crystal (“LC”) array. Performance can be enhanced by removing the three (sometimes four) red-green-blue (“RGB”) color filters per pixel. If desired the color filter could be replaced by just one color filter. Depending on the LC array design, this would increase the effective pixel size by at least a factor of three. Additionally, higher contrast/transmission technologies, including new liquid crystal developments is included.

Although a TFT LCD is employed by one or more embodiments, any functionally equivalent or better technology that meets the electrical, optical, mechanical and aesthetic requirements for the sunglasses/visors may be substituted. This includes future technologies as they develop, including technologies developed specifically for these devices. Embodiments include present and future cosmetic variations. The technology is unique in that it allows for real-time compensation and tracking of a bright interfering source. In one or more embodiments, depending on the sunglass technology, a UV filter may be added if needed.

The following discussion of one or more embodiments will describe the use of a small CMOS or CCD camera or other camera technologies, coupled with lens or lenses to sense the presence of a bright source or sources that interfaces with two-dimensional LC arrays located on each lens of a pair of sunglasses, severely attenuating only the bright source(s) as the light passes through the sunglasses. In order to avoid saturation and/or damage to the camera(s), the camera(s) may have optical filters to attenuate the photon flux. The attenuation may be accomplished in several ways: (1) Use of an optical density filter, (2) use of a narrow band optical interference filter, (3) use of either a low bandpass or a high bandpass optical filter, (4) use of an absorption filter, or (5) some combination of these filters. As will be explained later, each method has its own advantages and disadvantages for their respective applications. In any case, the optical filter will act as thresholding device so that the only effective signal received by the LC array will be within the area for which the bright source is present. Since the bright source will typically be much brighter than the surrounding scene, scatter from other sources or due to a diffuse sky will be essentially filtered out. It is also possible to adjust the adjacent transmission of the LC array based on the output of the threshold signal.

A better understanding of the features and advantages of one or more embodiments will be obtained by reference to the following detailed description of the embodiments and accompanying drawings, which set forth illustrative embodiments in which the principles of one or more embodiments are utilized.

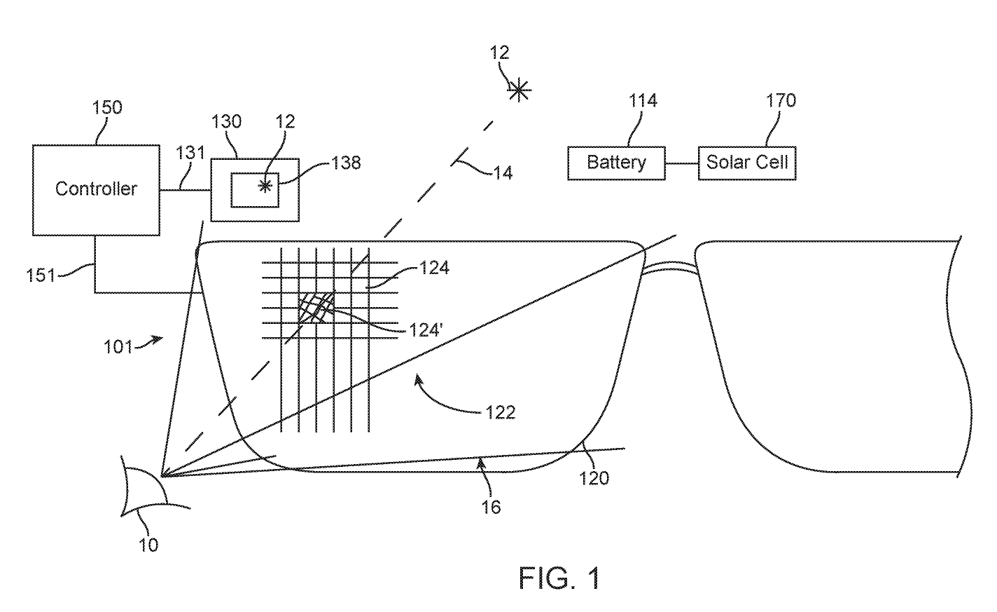

FIG. 1 depicts a schematic block diagram of protective eye gear 101 for selectively blocking localized regions of intense light from a field of view 16 in one or more embodiments. The protective eye gear 101 comprises a lens 120, at least one photosensor 130, and a controller 150. In this example, the protective eye gear 101 may be fashioned to appear as conventional sunglasses having two separate lenses. The protective eye gear may comprise visors or goggles in one or more embodiments.

The lens 120 is configured to be positioned in front of a user's eye 10 to form a field of view 16 for the user. The field of view 16 is the images or objects that are observable by the user's eye 10 through the lens 120.

In this example, a bright light source 12 generates a beam of light 14 that would otherwise enter into the naked eye 10 of the user. The light source 12 may be the Sun, light from a laser, light from an explosion, or light from the headlight of an oncoming car after dark. Glare from the light source 12 is especially pronounced when the bright light source 12 has substantially greater luminance than the surrounding objects.

The lens may have a two dimensional array 122 of electrically controllable, variable transparency elements 124. In one or more embodiments, the array 122 may be comprised of a pixelated liquid crystal display, in which the transparency may be changed electrically such as by applying voltage to the individual pixels 124. Recent advances in liquid crystal displays, such as from passive and active matrix LCD as well as thin-film transistor liquid crystal displays provide improved contrast and addressability.

The photosensor 130 is located in proximity to the lens 120 such that the photosensor monitors the images entering the field of view 16 of the user's eye 10 and provides an electrical image signal 131 to the controller 150. In this example, the image 138 represented here as a display on the photosensor 130 detects objects within the field of view 16 of the user wearing the protective eye gear 101. As shown, the bright light source 12 is detected by the photosensor 130 which will be communicated to the controller 150 as part of the image signal 131. In one or more embodiments, the photosensor 130 may be a camera, a CCD camera, or microbolometer focal plane array as discussed herein. In one or more embodiments, optical filters or an optical train or assembly of lenses may be employed and positioned in front of the photosensor 130.

The controller 150 is coupled to the lens 120 and the photosensor 130 and receives the image signal 131 from the photosensor 130. The controller 150 determines whether there are one or more regions of intense light within the field of view 16 of the user 10. The controller 150 maps the regions of intense light received by the photosensor 130 to the corresponding set of elements in the array 124′ receiving the intense light. The controller 150 generates a control signal 151 to the array 122 which selectively attenuates the transparency of the corresponding set of elements 124′ on the lens receiving the intense light. Hence, the bright light source 12 will be blocked from the field of view 16 of the user 10 by the darkened elements 124′, enabling the user 10 to safely view the remaining portion of the field of view 16. In one or more embodiments, the remaining field of view outside the attenuated elements on the lens remains clear or uniformly attenuated.

In one or more embodiments, the two dimensional array of elements 124′ may block the intense light by forming geometrical shapes to cover the regions of intense light 12. In an embodiment, the controller 150 thresholds and centroids the regions of intense light 14 and translates the coordinates to the lens 122 to block or attenuate the associated elements 124′. In one or more embodiments, the protective eye gear 101 may comprise a solar cell 170 and/or battery 114 for powering the eye gear 101. Generally, the solar cell 170, if used, will charge a battery 114; alternatively only a battery 114 may be used.

The controller 150 may comprise digital, analog, or a combination of digital and analog circuitry. In one or more embodiments, the controllers may comprise one or more of multiplexers, field programmable gate arrays, microprocessors, microcontroller, or other electronic devices.

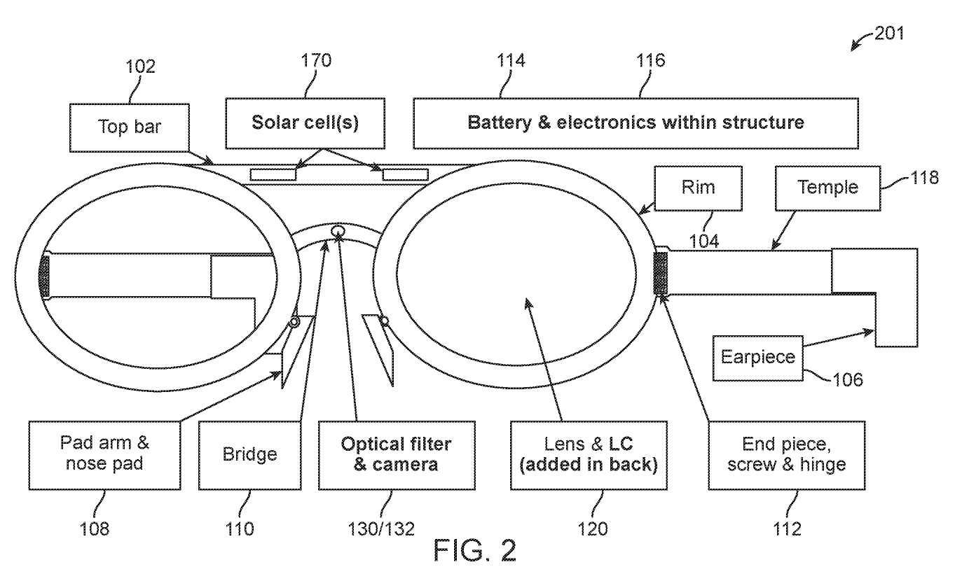

FIG. 2 is a depiction of solar and laser blocking (“ESOLAB”) eye gear 201 in one or more embodiments. Items in standard font are standard sunglass components such as the top bar 102, the rim 104, the earpiece 106, the pad 108, the bridge 110, the end piece 112, and the temple 118; items in bold italics such as the solar cells 170, batteries 114, electronics 116, the liquid crystal display 120, the camera 130 and optical filter 132 represent ESOLAB additions in one or more embodiments. Another possible configuration would place optical filters and cameras on the top of each Rim, removing the single camera from the Bridge. The specific cosmetics will vary, as will some of the more general details. For example, the use of Solar cells is an option. Although only one camera 130 is illustrated, it is also possible to utilize two cameras, one for each eye. As with commercially available sunglasses, the construction materials and details will vary. The placement of the camera 130, battery 114, solar cells 170 (if used), and electronics 116, including wiring and an external battery charger (if used), will depend on the final design. The sunglass “Lens” 120 material may be the same or similar to what is found on present-day sunglasses. The optical filter 132 placed over the camera (CMOS or equivalent) significantly reduces any signal coming from the camera 130. Whereas the background light sources will be reduced to around noise level (or slightly higher, depending on the final design), the Solar or laser source, being extremely bright will still produce a large output from the camera. After processing, the left and right camera signals will consist of the two dimensional coordinate positions of the bright source, mapped to the LC array 122 coordinates. Since the LC pixels will normally be in full transmission mode, the signals will reduce the transmission only of those pixels that map to the extremely bright optical source; for example, the Sun might appear as either a dark spot or a spot no brighter than the surrounding region. It is important to note, that although this description applies to the Sun, the optical source could also be a laser beam. If, for example, the ESOLAB were used by airplane pilots to eliminate laser threats, the sunglass lenses may not be tinted. One more point: although a LC array is illustrated, other technologies that would serve the same function may also be utilized (i.e., micro-shutters, etc.).

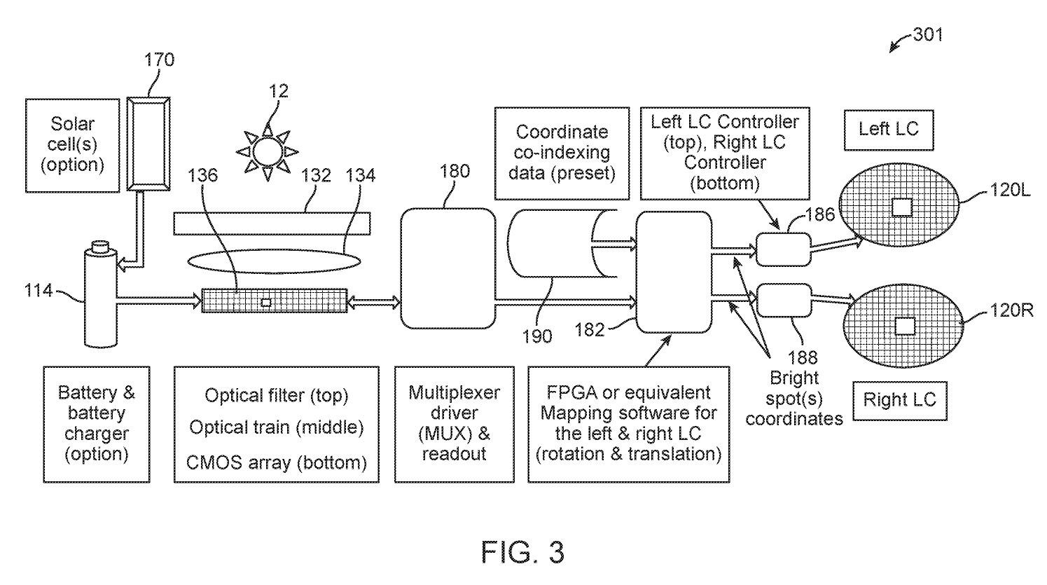

FIG. 3 is a functional schematic diagram and general illustration of the ESOLAB glasses 301. In one or more embodiments, an optical filter 132 and an optical train 134 are placed in front of the camera 136, represented here as a CMOS array. The CMOS array 136 communicates the image signal to a multiplexer driver and readout 180, which, in turn, communicates a signal to a Field Programmable Gate Array (“FPGA”) 182 or equivalent which determines the left and right liquid crystal coordinates through rotation and translation for example. A Coordinate Co-indexing Preset Data module 190 is also coupled to the FPGA 182. The FPGA 182 communicates the left and right bright spot coordinates respectively to the left liquid crystal controller 186 and the right liquid crystal controller 188. The controllers 186 and 188 attenuate or block the corresponding pixels on the left lens 120L and the right lens 120R.

An embodiment would be to translate the complete, thresholded image to the two lenses; this approach would be useful for the case where several bright interfering light sources are present. Any technologies that can perform the same functions as the camera and lenses are also covered in one or more embodiments.

Although the “Sun” 12 is illustrated in FIG. 3, the source could also be a laser beam. It is also possible to use two separate optical sensors for each eye. Due to optical thresholding, only the optical source would produce an effective signal out of the CMOS array. Standard mapping routines would rotate and translate (and scale and skew if necessary) that output onto the left and right LC arrays 120L and 120R, where the corresponding pixels would appear as either dark or dim spots.

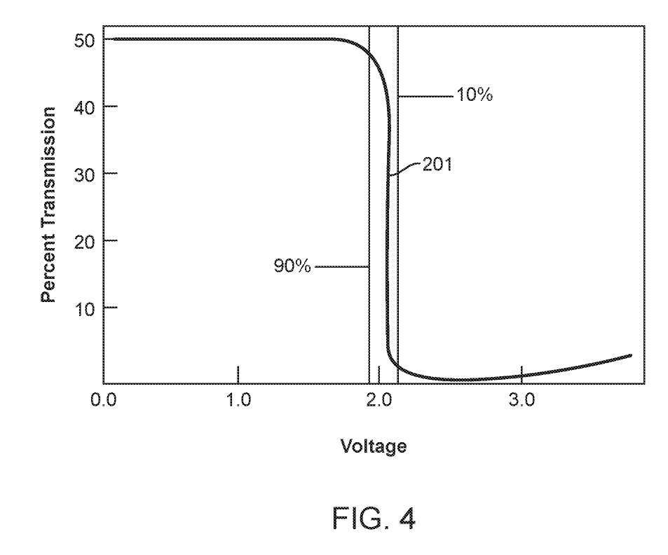

An example LC transmission curve is shown in FIG. 4. As shown, the percent transmission 201 though a Super Twisted Nematic Display liquid crystal display varies from approximately 50% for applied voltages less than 2 Volts to a percent transmission substantially less than 10% for voltages exceeding 2 Volts. The voltage signals from the LC Controller corresponding to an extremely bright source would switch the corresponding pixels, mounted on each sunglass lens from transmitting to non-transmitting.

The programming would be performed in a field programmable gate array (FPGA) or equivalent integrating circuits. Some performance details are discussed in the following paragraphs.

A critical issue is assuring that the CMOS camera does not get saturated or damaged by the bright source. In order to accomplish this task, we first need to characterize the optical signal from either a Solar or laser source. The Sun subtends an angle of 0.53° at the Earth's surface. Assuming an optical aperture diameter, D, of 8 mm (approximately that of a Logitech C270 webcam), diffraction-limited unobscured optics, and an average wavelength, λ, of 675 nm, then the diffraction spot diameter due to a collimated laser beam would be about 2.44*λ/D or 11.7E-3 degrees. Approximately 83% of this energy would be contained within this central (Airy) disk. Of course, for the cameras of interest, the optics will not be diffraction limited due to cost considerations and the fact that the pixel instantaneous field of view (“IFOV”) in the visible for small aperture cameras is much larger than the diffraction-limited spot diameter. Specifically, for an imaging camera, the optical and focal plane array Modulation Transfer Functions (“MTF's”) should have, ideally, matching spatial frequency response. That's equivalent to stating that the spot diameter due to a “Point source” should be roughly twice the pixel size, stated either in angular or linear dimensions.

For a rough order of magnitude (“ROM”) estimate, we will use the Logitech C270 web camera, configured in VGA mode (640×480 pixels). The FOV is given as 60 degrees; assuming this is a circular FOV, a ROM estimate is to take the number of pixels as the geometric mean of √(640·480) or 554 pixels.

With this assumption, the IFOV for each pixel is approximately 60/554 or 0.108°. While the solar image will be distributed over roughly (0.53/0.108)̂2=24 aggregate pixels (Nₛᵤₙₚᵢₓₑₗₛ), essentially all the energy in a collimated laser beam will distribute over one aggregate pixel. Commercially available lasers run from about 5 mW to about 100 Watts. Setting the maximum laser power φ=100 w, the range R=1000 m, the beam divergence half-angle α=1.5E-3 radians, the aperture diameter D=8 mm, the amount of power P deposited on one pixel due to laser is given by

$${P}_{laser} = \frac{π {D}^{2}}{4} \cdot \frac{Φ}{{( α \cdot R )}^{2}} = 2.2 \cdot {10}^{- 3} Watts \text{/} pixel$$

In contrast, the solar irradiance (Iₛᵤₙ) is over the sensor's response (300-1005 nm) is approximately 716 W/m̂2 distributed over 24 aggregate pixels, or J=30 W/m̂2 per aggregate pixel. The power due to the solar irradiance per pixel for 100% optical throughput is then

$${P}_{sun} = \frac{π {D}^{2}}{4} \cdot J = 1.5 \cdot {10}^{- 3} Watts \text{/} pixel$$

Consequently, the attenuation requirements for both laser and Solar suppression are similar. However, the filter types may need to differ. Since Solar suppression might be required over a considerably longer period, an interference or lowpass/highpass filter, in possible combination with a neutral density filter or absorptive filter, may be used to reflect unwanted photons and avoid overheating of the optical filter, optical train, and CMOS FPA. Between a lowpass or highpass filter, a highpass filter would probably be preferable due to the significantly reduced responsivity of CCD or CMOS silicon detectors to wavelengths above approximately 1000 nm. On the other hand, since lasers have various narrow wavebands, a neutral density filter (absorption filter) would probably be preferable for laser applications. Neutral density filters are have a weak wavelength independence; furthermore, it is unlikely that a laser beam would remain focused on the glasses long enough to cause significant heating. One last point: in the laser application, absorption (i.e., tinting, etc.) of the sunglass lenses would be optional—that is, the standard sunglass function may not be needed or desired.

In order to estimate the optical filter requirements, it is necessary to determine the signal per (CCD or CMOS) pixel due to the various sources. The photoelectrons per pixel produced by direct illumination of the Sun is given by

$${N}_{sundirect} = {P}_{sun} \cdot {τ}_{optics} \cdot {τ}_{filter} \cdot t \cdot QE \cdot \frac{λ}{h \cdot c}$$

Where τ_{optics} is the optical throughput, τ_{filter} is the optical filter attenuation, QE is the average quantum efficiency, t is the integration time (not the frame time), h is Planck's constant (6.625E-34 Joule-sec) and c is the speed of light (3E8 m/s). Reasonable numbers for these parameters are: τ_{optics}=0.80, QE=0.30, and λ=675 nm. The requirement for the product of τ_{filter} and t is that N_{sundirect} is less than the electron storage capacity but large enough to assure a strong signal and signal to noise ratio without saturating the pixel. Setting N_{sundirect} equal to a typical small CMOS or CCD saturation level of about 25000 electrons, then the above equation yields τ_{filter}·t=2.0E-10 seconds. Since optical density filters (OD) don't usually go beyond approximately 4, two such OD filters would set the integration requirement to

$$t = \frac{2.0 \cdot {10}^{- 11}}{{10}^{- 4} \cdot {10}^{- 4}} = 2.0 mseconds$$

On the other hand, the background illumination is spread over the whole focal plane, producing the following photoelectrons per aggregated pixel

$${N}_{bkgnd} = {R}_{bkgnd} \cdot ( \frac{π {D}^{2}}{4} ) \cdot {( IFOV )}^{2} \cdot {τ}_{optics} \cdot QE \cdot {τ}_{filter} \cdot t \cdot \frac{λ}{h \cdot c}$$

Where the IFOV is expressed in radians, and R_{bkgnd} is the background Radiance in W/m̂2/Sr. Assuming Lambertian reflection and using the Earth's average albedo, α, of 30%, R_{bkgnd}≈α·Iₛᵤₙ/π=68 W/m̂2/Sr. If we set α=100%, R_{bkgnd} increases to 228 W/m̂2/Sr.

Plugging in these numbers and using the larger value for R_{bkgnd}, we obtain N_{bkgnd}=0.85 photoelectrons. For this size pixel, the storage capacity would be about 25000 electrons, so saturation is not an issue. Note N_{sundirect} dominates all the currents, including dark current, as can be seen for the following sentences. The dark current, I_{dc}, and read noise, N_{read}, were not readily available for this sensor; however, a conservative upper bound on these quantities (for an expected operating temperature and aggregated pixels) is I_{dc}=600 electrons/sec/(aggregated pixel), and N_{read}=20 electrons. Then the signal to noise ratios (SNR) for the direct solar and background are given, respectively, by

$${SNR}_{sundirect} = \frac{{N}_{sundirect}}{\sqrt{{N}_{sundirect} + {N}_{bkgnd} + {I}_{d c} \cdot t + {N}_{read}^{2}}} = 156$$

$${SNR}_{bkgnd} = \frac{{N}_{bkgnd}}{\sqrt{{N}_{bkgnd} + {I}_{d c} \cdot t + {N}_{read}^{2}}} = 0.04$$

As expected, SNR_{sundirect} is very large, whereas SNR_{bkgnd} is in the noise, so only the position of the Sun is outputted. Since, for our example, the irradiance of the laser is effectively about the same as that for the Sun, the output results would be similar; the only difference would be that the Sun would cover more pixels due the finite angle it subtends as seen on the Earth.

These estimates are conservative in that the storage capacities used here are on the lower end of sensor technology. Furthermore, since color is not an issue with the camera, larger monochromatic pixels will produce significantly higher saturation capacities (e.g., there is no need for red, green and blue pixels).

The transparent screen's contrast requirement is dependent of the relative amounts of direct and indirect sunlight or lighting. Direct sunlight produces approximately 100000 lux of illuminance, whereas home lighting produces from 30 to 300 lux and office desk lighting from 100 to 1000 lux. Most TFT LCD monitors, including the ones used for this demonstration have contrast ratios around 300:1 to 500:1. If we take the lower end of the contrast ratio, direct sunlight would be reduced to 10000/300 or 333 lux, an acceptable level. Indeed, the contrast specifications for the LCD-057-TRN and LCD-997-TRN are 415:1 and 800:1, respectively. The contrast requirement of approximately 300:1 is much lower than the optical filter requirement for the camera: this is reasonable as the transparent LCD is not focusing light onto a very small area.

The preceding description of the presently contemplated best mode of practicing preferred embodiments is not to be taken in a limiting sense, but is made merely for the purpose of describing the general principles of the preferred embodiments.

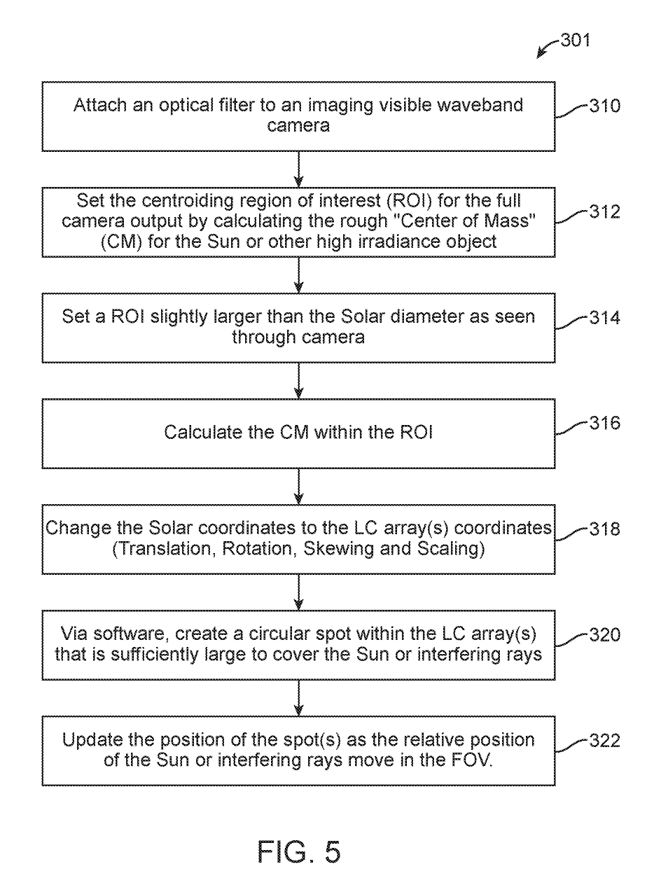

FIG. 5 is a flowchart illustrating an exemplary process for determining pixels that are to be darkened or attenuated 124′ in response to a bright light entering the field of view of the user. Since the eye response is around 100 milliseconds (although the fastest response has been measured at 13 milliseconds), a camera frame time of about 16.7 or 33.3 milliseconds (60 and 30 Hz frame rates, respectively) should be more than sufficient for fast switching of the LC array with available technology. Algorithms were developed to map the position of the Sun (or other offending signal) from the camera onto the LC sunglass lenses. In the actual software model and the physical demonstration unit described herein, the following methodology was very effective:

First, attach an optical filter to an imaging visible waveband camera (step 310). This may avoid saturation, adds optical thresholding, significantly reducing scatter and other sources, thus simplifying centroiding.

Second, set the centroiding region of interest (ROI) (i.e., regions of intense light in a field of view) for the full camera output (step 312). Calculate the rough “Center of Mass” (CM) for the Sun or other high irradiance object.

Third, set a ROI slightly larger than the Solar diameter as seen through camera (step 314). The size of the ROI is just large enough to centroid the Solar position, including alignment, round-off and other errors.

Fourth, calculate the CM within the ROI (step 316). This produces the two-dimensional coordinate position of the Sun with sufficient accuracy.

Fifth, change the Solar coordinates to the LC array(s) coordinates (step 318). In the software and demonstration unit only translation is used for one LC array. Both the software and demonstration unit have the capability of Translation, Rotation, Skewing and Scaling of the image. The same procedures applies for two LC arrays (i.e., left and right eye pieces).

Sixth, via software, create a circular spot within the LC array(s) that is sufficiently large to cover the Sun or interfering rays (step 320).

Seventh, update the position of the spot(s) as the relative position of the Sun or interfering rays move in the FOV (step 322).

The electronic threshold, solar attenuation, and type and amount of coordination transformations are adjustable via a text input to the program. The demonstration unit has a frame rate of approximately 4 Hz; however, with dedicated and better integrated hardware and software, frame rates of 60 Hz or better should easily be achieved. Ordinary cameras and camcorder with built in displays transfer the image to the display with a 30 to 60 Hz frame rate.

In this incarnation, only the CM of the spot is transformed to the appropriate position(s) in the LC array(s). An alternative approach is to transform the thresholded image to the corresponding position(s) in the LC array(s), although this would probably take more processing power and time.

Functionally, the centroiding and translating may also be accomplished with image translation/rotation/skewing algorithms. The function of the transparent LCD may also be accomplished with functionally equivalent technology.

In one or more embodiments, only one camera may be required since its images can be rotated and translated (i.e., mapped) onto each of the two sunglass LC arrays. Alternatively, two cameras may also be used, each with its own optical filter and software/hardware segments. The unit could either be battery powered, solar/battery powered or even rechargeable. The final decision would be based on trades concerning processing speed, power consumption, size, weight, ergonomics, and costs.

A “proof of concept” system comprising hardware and software was developed to explore the issues presented herein. Other than several ancillary programs, two main programs were developed; the first program, cameraImage_To_transparentLCDrev4, herein called “software simulation,” is a computer simulation to test and validate the algorithms. The second program, sunBlockProgramRev2, herein called “interface program,” is a control and hardware interface program: specifically, it interfaces with and between the camera, the computer and its monitor, and the transparent liquid crystal display.

Since the final product was the hardware interface program, which was, in many ways similar to the software simulation, we will proceed with a brief description of the software simulation while illustrating some of its inputs and outputs.

The inputs to the software simulation program are shown in Table I below. Table I lists inputs to the software simulation program (cameraImage_To_transparentLCDrev4). Note that the input camera image is simulated with a jpeg image. The input Excel file name is cameraImage_To_transparentLCD_Inputs.xlsx.

TABLE I

| Camera Image File | | |
|---|---|---|
| Name (jpg) = | Camera.jpg | Description |
| Transparent LCD File | Transparent_LCD.jpg | |
| Name (jpg) = | | |
| imageSizeX = | 640 | Number of camera or LCD pixels |
| | | (assumed equal) in the x (horizontal) |
| | | direction, pixels |
| imageSizeY = | 480 | Number of camera or LCD pixels |
| | | (assumed equal) in the y (vertical) |
| | | direction, pixels |
| Contrast = | 2 | Contrast used for centroiding |
| | | (Background Image)/(Circular |
| | | Obscuration). This is only used in the |
| | | camera for centroiding, unitless |
| TTB = | 0.7 | Threshold to background ratio. This is |
| | | only used in the camera for |
| | | centroiding, it is between 0 and 1 |
| | | (maximum thresholding), unitless |
| CameraCenterX = | 371 | X (horizontal) position of Sun as seen |
| | | in camera, in pixels, integer |
| CameraCenterY = | 202 | Y (vertical) position of Sun as seen in |
| | | camera, in pixels, integer |
| radius = | 18 | Radius of the Sun used in the camera |
| | | image, in pixels, integer |
| ROImultiplier = | 6 | Region of interest (x or y width) |
| | | multiplier: ROI = ROImultiplier*radius, |
| | | ROImultiplier should be >2. Used for |
| | | centroiding, integer |
| LCDcenterX = | 377 | X (horizontal) position of the Sun as |
| | | seen through the LCD display, pixels, |
| | | integer |
| LCDcenterY = | 213 | Y (vertical) position of the Sun as seen |
| | | through the LCD display, pixels, |
| | | integer |
| MaskRadiusMultiplier = | 0.7 | MaskRadius = |
| | | MaskRadiusMultiplier*radius, where |
| | | MaskRadius is the radius of the mask |
| | | to hide the Sun in the transparent LCD |
| | | display, pixels |
| SunSpotCenterValues = | 255 | Value given to the final mask (center |
| | | pixels) used in the LCD transparent |
| | | display. This is based on a uint8 (8-bit) |
| | | color image |
| | | (i.e., SunSpotCenterValues = 2\hat{ }(bits-1) = |
| | | 2\hat{ }7 = 255) |
| LCDtransmission = | 0.5 | Transparent LCD (Sunglass) |
| | | transmission, fraction |
| SolarMaskEfficiency = | 0.7 | Solar Mask efficiency (inputted to LCD |
| | | or sunglasses) (fraction of the Sun's |
| | | energy obscured), fraction |

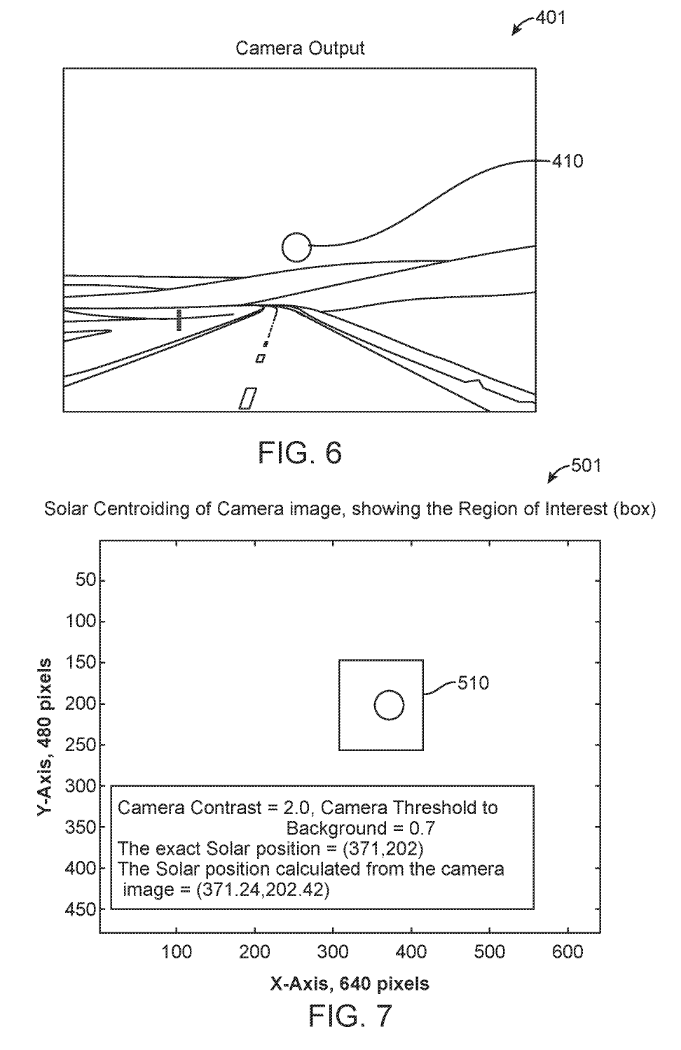

FIGS. 6 and 7 shows an illustration of the input image (camera output) and its thresholded and centroided image. FIG. 6 is an illustrated input image 401 to the proof of concept system showing the Sun 410 above a highway. FIG. 7 illustrates the Solar Centroiding 501 of the camera image showing the region of interest 510 surrounding the position of the Sun 410. Here, the Camera Contrast was 2.0, and the Camera threshold to background is 0.7. The exact Solar position is (371, 202), and the Solar position calculated from the camera image is (371.24, 202.42).

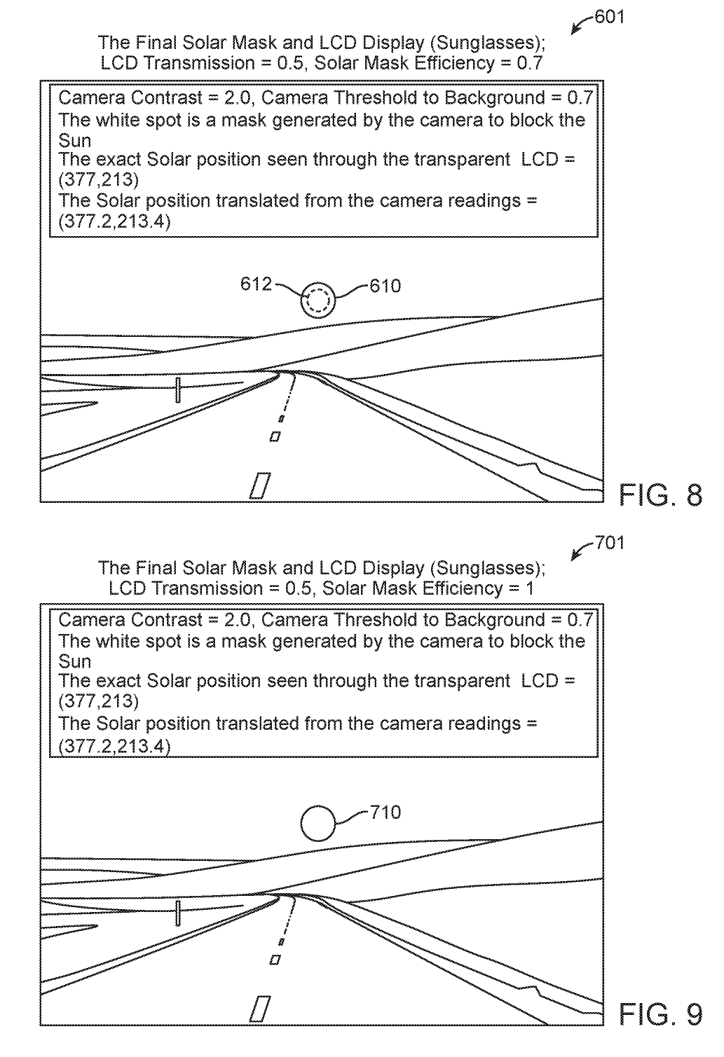

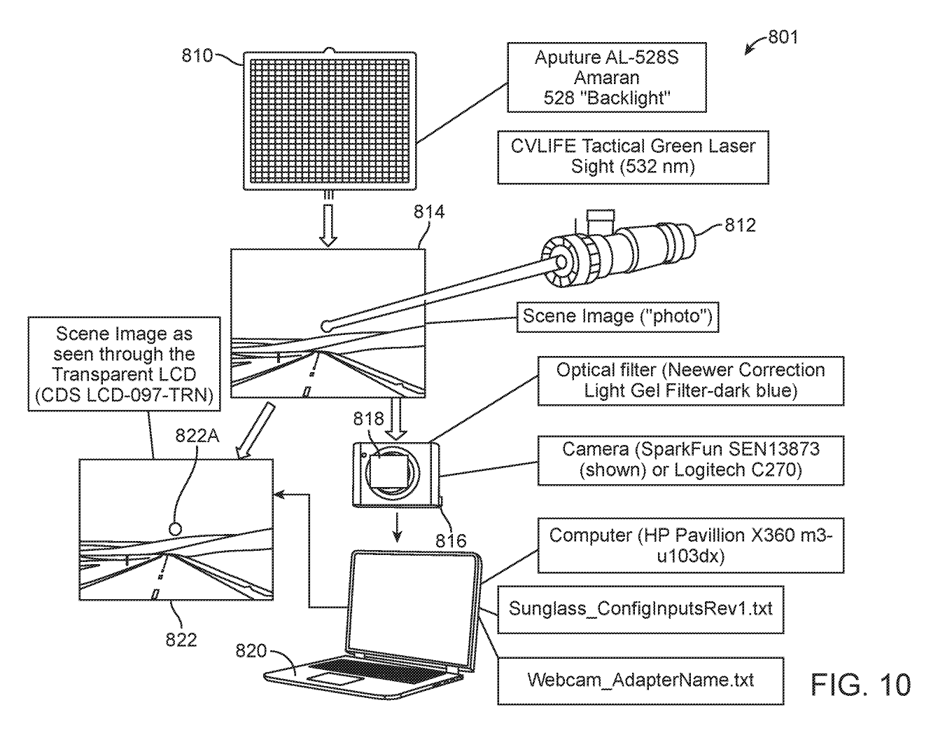

FIGS. 8 and 9, are illustrations based on actual models with a simulated masked Sun for mask efficiencies of 70% and 100%. FIG. 8 shows the final Solar Mask and LCD display 601 for the sunglasses where the LCD transmission, exclusive of the Sun, is 0.5, and the Solar mask efficiency is 0.7. The camera contrast is 2.0, and the camera threshold to background is 0.7. The white spot 610 is a mask generated by the camera to block the Sun. In the original color image, the 610 is slightly colored, indicating 70% solar transmission: in the illustration, this is represented by a dashed circle 612. The exact Solar position seen through the transparent LCD is (377, 213). The Solar position translated from the camera reading is (377.2, 213.4).

FIG. 9 shows the final Solar Mask and LCD display 701 for the sunglasses where the LCD transmission is 0.5, and the Solar mask efficiency is 1.0. The camera contrast is 2.0, and the camera threshold to background is 0.7. The white spot 710 is a mask generated by the camera to block the Sun. At this transmission, the Sun is completely blocked and the “Dashed circle” is not shown. The exact Solar position seen through the transparent LCD is (377, 213). The Solar position translated from the camera reading is (377.2, 213.4).

The hardware interface program was, by definition, more sophisticated. An illustration of the overall system for the proof of concept development is shown in FIG. 10.

FIG. 10 is a functional flow of the Hardware Interface Program showing the actual components used for the proof of concept. The system 801 comprises a backlight 810, a tactical green laser sight 812, a scene 814, a camera 816, an optical filter 818, a computer 820, and a scene image 822 as seen through the transparent LCD. The laser sight 812 is aimed to the scene photo 814 and generates a bright spot. The camera 816 observes the scene image and transmits the image signal to the computer 820 for processing. The computer 820 then generates the obscuring spot (822A) on the transparent LCD.

In the final product, all the components would be micro-miniaturized within the sunglasses. The power could be supplied by battery(s) or battery/solar cell combinations.

The illustrations are of the actual components used. The final image 822 is a black and white line drawing representation of an actual output. The actual image of the output may exhibit some blurring where much of the blurring is due to diffuser and brightness enhancement film (“BEF”) in the LC array. An embodiment may use a smaller transparent LCD (CDS LCD-057-TRN) with no diffuser or BEF. Use of the newer transparent LCD should not require any changes to the hardware interface program as it uses a configuration file (sunglass_ConfigInputsRev1.txt) to adjust for sensor, computer and transparent LCD changes. The other text file, webcam_AdapterName.txt, only has one input, the name of the video adapter: for Microsoft windows it is winvideo.

Before proceeding, it is useful to examine the configuration file inputs. In Table II, we illustrate some sample values. These are the configuration inputs to the hardware interface program. The quotation marks separate the values from the text. Most of the definitions are self-evident; other definitions that require more clarity are augmented below.

TABLE II

| Parameter | Value | Description |
|---|---|---|
| “LcdSizeX” | 640 | “Number of LCD pixels (best if imageSizeX = |
| | | pixelScaleX) in the x (horizontal) direction, pixels” |
| “LcdSizeY” | 480 | “Number of LCD pixels (best if imageSizeY = |
| | | pixelScaleY) in the y (vertical) direction, pixels” |
| “iSnapShots” | 100 | “Number of snapshots (frames) to take, integer >= 1” |
| “TTB” | 0.90 | “Threshold to background ratio. This is only used in |
| | | the camera for centroiding, it is between 0 and 1 |
| | | (maximum thresholding), unitless” |
| “displayKey” | 0 | “Set equal to 1 to display all the images; set = 0 to |
| | | only display the Mask image” |
| “printKey” | 0 | “Set equal to 1 to print interim data; set = 0 |
| | | otherwise” |
| “radius” | 10 | “Radius of the Sun/Laser spot, in pixels, integer” |
| “ROImultiplier” | 4 | “Region of interest (x or y width) multiplier: ROI = |
| | | ROImultiplier*radius, ROImultiplier should be >2. |
| | | Used for centroiding, integer” |
| “MaskRadiusMultiplier” | 2 | |
| “SunSpotCenterValues” | 255 | |
| “SolarMaskEfficiency” | 1 | |
| “frameTimeKey” | 1 | “If 1, display the frame time; if 0 don't display the |
| | | frame time” |
| “getGcfPosition” | 0 | “Set = 1 to find the position of the monitor image, set = |
| | | 0 otherwise (this should be a one time event)” |
| “gcfPosition(1)” | 1252 | “Horizontal starting pixel for transparent monitor (set |
| | | getGcfPosition = 1 to obtain by moving the final |
| | | image to the second monitor)” |
| “gcfPosition(2)” | 86 | “Vertical starting pixel for transparent Monitor (set |
| | | getGcfPosition = 1 to obtain by moving the final |
| | | image to the second monitor)” |
| “cameraResizeKey” | 1 | “If 1, use CameraPixelX and CameraPixelY; if 2, use |
| | | CameraScaler (i.e, 0.5 or 2, etc); if 0, don't scale, |
| | | integer” |
| “cameraPixelX” | 640 | “Number of columns to scale camera to. Applies iff |
| | | cameraResizeKey = 1, (typical value is 640), integer” |
| “CameraPixelY” | 480 | “Number of rows to scale camera to. Applies iff |
| | | cameraResizeKey = 1, (typical value is 480), integer” |
| “CameraScaler” | 4 | “Scaler amount to scale the camera image. Applies |
| | | iff cameraResizeKey = 2, it could be 0.5 or 2 etc” |
| “webcamNumber” | 2 | “Number of device in videoinput” |
| “translateKey” | 0 | “Enter 0 if you want to estimate XL_CM & YL_CM |
| | | [LCD CM}, enter 1 if you want to calculate XL_CM & |
| | | YL_CM using simple registration, integer” |
| “deltaLCDcenterX” | 10 | “X (horizontal) estimated inaccuracy of the position |
| | | of the Sun spot seen through the transparent LCD, |
| | | use iff translateKey = 0, pixels” |
| “deltaLCDcenterY” | 20 | “Y (vertical) estimated inaccuracy of the position of |
| | | the Sun spot seen through the transparent LCD, use |
| | | iff translateKey = 0, pixels” |
| “XC_1” | 0 | “First X (horizontal) registration point, as seen in the |
| | | camera, use iff translateKey = 1, pixels” |
| “YC_1” | 0 | “First Y (vertical) registration point, as seen in the |
| | | camera, use iff translateKey = 1, pixels” |
| “XC_2” | 640 | “Second X (horizontal) registration point, as seen in |
| | | the camera, use iff translateKey = 1, pixels” |
| “YC_2” | 480 | “Second Y (vertical) registration point, as seen in the |
| | | camera, use iff translateKey = 1, pixels” |
| “XL_1” | 0 | “First X (horizontal) registration point as seen |
| | | through the transparent LCD, use iff translateKey = |
| | | 1, pixels” |
| “YL_1” | 0 | “First Y (vertical) registration point, as seen through |
| | | the transparent LCD, use iff translateKey = 1, pixels” |
| “XL_2” | 640 | “Second X (horizontal) registration point, as seen |
| | | through the transparent LCD, use iff translateKey = |
| | | 1, pixels” |

LcdSizeX and LcdSizeY refers to the transparent LCD display, referenced as a second monitor by the computer. radius and MaskRadiusMultiplier could be replaced by just one variable since only MaskRadiusMultiplier*radius is used. The variable radius is a “Legacy” parameter that was necessary only during the computer simulation phase. webcamNumber is 2 as the HP notebook already has a built-in webcam that is not being utilized. translateKey determines how the measured center of mass of the “Sun” (laser spot) is translated to match up with the spot image as viewed through the transparent LC array. When translateKey=0, a 4-D matrix is used to perform the transformation. If translateKey=1, translation occurs via aligning four point on the image with the corresponding four points as seen through the transparent LCD

The 4-D transformation matrix is a standard procedure and need not be described. It should be mentioned, however, that the matrix used in the program has the capability of translation, rotation, scaling and skewing. At present only translation is used.

When translateKey=1, if (XL_{CM}, YL_{CM}) is the desired position of the center of mass in the transparent LCD, then the following algorithms apply

$${m}_{x} = \frac{{XL}_{2} - {XL}_{1}}{{XC}_{2} - {XC}_{1}} , {m}_{y} = \frac{{YL}_{2} - {YL}_{1}}{{YC}_{2} - {YC}_{1 }}$$

$${XL}_{CM} = {m}_{x} \cdot ( {XC}_{CM} - {XC}_{1} ) + {XL}_{1}$$

$${YL}_{CM} = {m}_{y} \cdot ( {YC}_{CM} - {YC}_{1} ) + {YL}_{1}$$

Where XC_{CM} and YC_{CM} are the x and y coordinates of the center of mass measured in the camera.

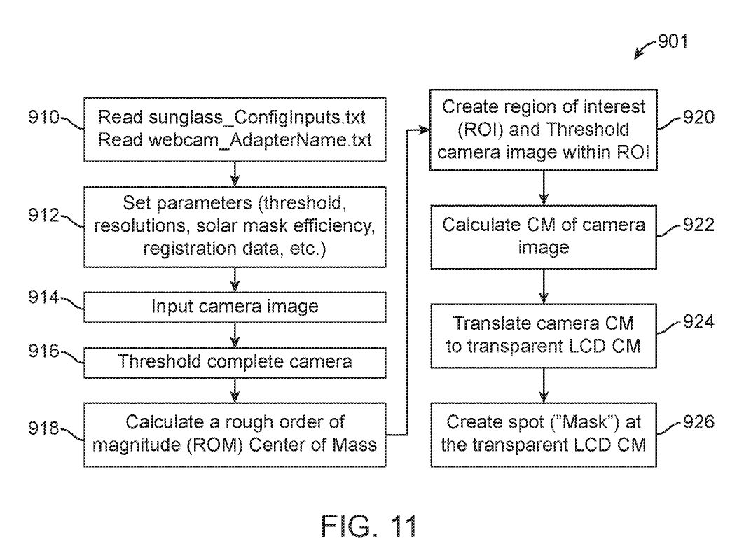

The basic functions of the hardware interface program are shown schematically in FIG. 11. It is important to note that only a single 2-D point is translated, not an image: this assures very fast computer time and vastly simplifies the algorithms. FIG. 11 illustrates the basic configuration of the hardware interface program (details not shown for clarity).

As shown in FIG. 11, the computer 820 reads the input files sunglass_ConfigInputsRev1.txt and webcam_AdapterName.txt (step 910). The computer 820 sets parameters such as threshold, resolutions, solar mask efficiency, registration data, and so forth (step 912). The camera image is used as an input to the system (step 914). The threshold of the camera is generated (step 916). The computer 820 calculates the rough order of magnitude (ROM) of the center of mass (step 918). The computer 820 creates a region of interest (“ROI”) and a threshold camera image within the region of interest (step 920). The CM is calculated (step 922). The camera CM is translated to the transparent LCD CM (step 924). A spot or mask is created at the LCD CM (step 926).

A proof-of concept software/hardware demonstration validated the concept. A high power green gun sight laser operating at 532 nm was used as a Sun substitute.

Parallax is an issue only in the demonstration unit because of the small distance between the simulated “Sun” and the eye, the view angle is very important. Alignment is most accurate when the eye is very close to the transparent LCD. For example, assuming the distance between eyes is 3.25 inches (7.6 cm), an object two feet away would present a parallax angle of approximately 3.25/24*57.3° or about 7.8°. For the Sun, parallax is not an issue since it is 1.5E8 meters away: for the Sun, the parallax angle would be approximately 0.076/1.5E8*57.3°=3.2E-8°.

One or more embodiments comprise a smaller unit. However, a brief, tentative, description of these embodiments is warranted. Embodiments may use the CDS LCD-057-TRN transparent display. This is a much smaller device, with a 5.7″ diagonal screen compared to the 9.7″ diagonal screen used for the present demonstration. Furthermore, being a special order, it does not have the diffuser or BEF's with which the larger screen came supplied and should have a clearer image. For illumination, we ordered two Adafruit 45 mm×86 mm backlights. A rough estimate is that the completed demonstration unit will fit in a box approximately 6″ wide by 5″ high by 3.5″ deep.

The production unit will be miniaturized to fit within the confines of the geometry of sunglasses and visors. In order to do this, and to assure clear transmission through the LCD (or its alternative), the following enhancements will happen.

Use of larger monochrome pixels. For example, the solar angular diameter is 0.53°, so that a resolution (IFOV) of 0.10° should be adequate. If the FOV is 30° then the number of pixels is about 30/0.10 or 300 pixels, requiring a small (90,000 pixel) camera. Since the camera would be monochromatic, and not polychromatic, the effective pixel size would be 3-4 times larger than for a standard camera. It should be easier to make the electrodes even more transparent because of all the added real estate. The driver transistors on the LCD will also take up a much smaller fraction of the area. Indeed, due to the small array size, it may be possible to access the individual pixels without use of TFT technology which is required for larger array.

One or more embodiments may include: engineering highly transparent electrodes for the LCD. Use of other transparent screens as they become viable. Integrate the camera-software-electronics-battery-solar cell (if used) screen into a miniaturized system. Depending on the technology, it may be necessary to add an UV protection coating but this should not be an issue. Keep the final product cost at the right price point.

Although the preferred embodiments have been discussed with reference to specific embodiments, it is apparent and should be understood that the concept can be otherwise embodied to achieve the advantages discussed. The preferred embodiments above have been described primarily as electronic sunglasses that selectively block regions of intense light from entering into the eye of a wearer.

A sunglass using a transparent, pixelated, liquid crystal (LC) two-dimensional array, or functionally equivalent technology, in possible combination with optical materials to selectively attenuate or block the Sun or its reflection from the field of view (FOV) of the person wearing the glasses is disclosed. An imaging camera located within the sunglasses detects the Sun, with software determining its position via centroiding algorithms. The Solar position is then translated, and, if necessary, rotated, scaled and skewed for the appropriate pixels in the left and right lens of the sunglass, where left eye and right eye “disks” are created to block or attenuate the Sun's image from the person wearing the glasses. Only the image of the Sun if impacted; however, in future embodiments, the adjacent pixels might also be attenuated but to a lesser degree. The camera will have an optical filter to avoid damage caused by the intense irradiance of the Sun. Additionally, the sunglass lens will have protection against the Sun's ultra-violet (UV) rays. The internal power source may be either replaceable, or charged by solar or standard methods. One or more embodiments also apply to related applications, such as welding and laser protection.

In this regard, the foregoing description is presented for purposes of illustration and description. Furthermore, the description is not intended to limit the preferred embodiments to the form disclosed herein. Accordingly, variants and modifications consistent with the following teachings, skill, and knowledge of the relevant art, are within the scope of the preferred embodiments. The embodiments described herein are further intended to explain modes known for practicing the preferred embodiments disclosed herewith and to enable others skilled in the art to utilize the preferred embodiments in equivalent, or alternative embodiments and with various modifications considered necessary by the particular application(s) or use(s) of the preferred embodiments.

Acronyms

| | |
|---|---|
| BEF: | Background Enhancement Film |
| CCD: | Charge Coupled Device |
| CM: | Center of Mass |
| CMOS: | Complementary Metal Oxide Semiconductor |
| ESOLAB: | Electronic Solar and Laser Blocking Sunglasses |
| FOV: | Field of View |
| IFOV: | Instantaneous Field of View |
| LC: | Liquid Crystal |
| LCD: | Liquid Crystal Display |
| RGB: | Red-Green-Blue |
| ROI: | Region of Interest |
| TFT: | Thin Film Transistor |
| UV: | Ultra Violet |
| VLWIR: | Very Long Wave Infrared |

What is claimed is:

1. Protective gear for a user's eye for selectively blocking one or more regions of intense light from a field of view of the user, the protective gear comprising:
a lens configured to be positioned in front of the user's eye in the field of view of the user, the lens having a two dimensional array of electrically controllable, variable transparency elements;
at least one photosensor located in proximity to the lens, the photosensor monitoring the images entering the field of view of the user and providing an electrical image signal; and,
a controller coupled to the lens and the photosensor, the controller receiving the electrical image signal from the photosensor and determining the one or more regions of intense light within the field of view of the user, the controller mapping the one or more regions of intense light received by the photosensor to the corresponding set of elements on the lens receiving the one or more regions of intense light, the controller selectively attenuating the transparency of the corresponding set of elements on the lens receiving the one or more regions of intense light.

2. The protective gear for the user's eye for selectively blocking the one or more regions of intense light from the field of view of the user of claim 1, further comprising a solar cell charging a battery connected to the protective gear for powering the protective gear.

3. The protective gear for the user's eye for selectively blocking the one or more regions of intense light from the field of view of the user of claim 1, further comprising a battery connected to the protective gear for powering the protective gear.

4. The protective gear for the user's eye for selectively blocking the one or more regions of intense light from the field of view of the user of claim 1, wherein the two dimensional array of electrically controllable, variable transparency elements may block the intense light by forming geometrical shapes to cover the regions of intense light.

5. The protective gear for the user's eye for selectively blocking the one or more regions of intense light from the field of the user of view of claim 1, wherein the controller thresholds and centroids the regions of intense light and translates the coordinates to the lens to attenuate the associated elements.

6. The protective gear for the user's eye for selectively blocking the one or more regions of intense light from the field of view of the user of claim 1, wherein the a two dimensional array of electrically controllable, variable transparency elements comprises a liquid crystal display matrix.

7. The protective gear for the user's eye for selectively blocking the one or more regions of intense light from the field of view of the user of claim 1, wherein the a two dimensional array of electrically controllable, variable transparency elements comprises an active matrix liquid crystal display.

8. The protective gear for the user's eye for selectively blocking the one or more regions of intense light from the field of view of the user of claim 1, wherein the remaining field of view outside the attenuated elements on the lens remains uniformly attenuated.

9. The protective gear for the user's eye for selectively blocking the one or more regions of intense light from the field of view of the user of claim 1, wherein the photosensor is a camera.

10. The protective gear for the user's eye for selectively blocking the one or more regions of intense light from the field of view of the user of claim 1, wherein the photosensor is a charge coupled device (“CCD”) camera.

11. The protective gear for the user's eye for selectively blocking the one or more regions of intense light from the field of view of the user of claim 1, wherein the photosensor is a complementary metal-oxide-semiconductor (“CMOS”) device.

12. The protective gear for the user's eye for selectively blocking the one or more regions of intense light from the field of view of the user of claim 1, wherein the protective eye gear is configured to appear as conventional two-lenses sunglasses.

13. A method for selectively blocking localized regions of light from a field of view in a protective eye gear comprising a lens having a two dimensional array of electronically controllable, variable transparency elements, a photosensor, and a controller, the method comprising:
monitoring a field of view of a user;
determining one or more regions of intense light within the field of view;
mapping the regions of intense light to specific electronically-controllable variable transparent elements receiving the regions of intense light in the field of view of the user; and,
selectively attenuating the transparency of the specific elements positioned in the regions of intense light.

14. The method for selectively blocking localized regions of light from a field of view in a protective eye gear comprising a lens having a two dimensional array of electronically controllable, variable transparency elements, a photosensor, and a controller of claim 13, further comprising setting a centroiding region for a full camera output by calculating a rough Center of Mass for the regions of intense light

15. The method for selectively blocking localized regions of light from a field of view in a protective eye gear comprising a lens having a two dimensional array of electronically controllable, variable transparency elements, a photosensor, and a controller of claim 13, further comprising setting a region of interest (ROI) slightly larger than the dimension of the region of intense light.

16. The method for selectively blocking localized regions of light from a field of view in a protective eye gear comprising a lens having a two dimensional array of electronically controllable, variable transparency elements, a photosensor, and a controller of claim 13, further comprising calculating the center of mass within the region of interest.

17. The method for selectively blocking localized regions of light from a field of view in a protective eye gear comprising a lens having a two dimensional array of electronically controllable, variable transparency elements, a photosensor, and a controller of claim 13, further comprising changing the coordinates of the region of intense light to the two-dimensional array of elements;

18. The method for selectively blocking localized regions of light from a field of view in a protective eye gear comprising a lens having a two dimensional array of electronically controllable, variable transparency elements, a photosensor, and a controller of claim 13, further comprising generating a circular spot within the two-dimensional array of electronically controllable, variable transparency elements that is sufficiently large to block the regions of intense light.

19. The method for selectively blocking localized regions of light from a field of view in a protective eye gear comprising a lens having a two dimensional array of electronically controllable, variable transparency elements, a photosensor, and a controller of claim 13, further comprising updating the position of the regions of intense light as the region of intense light moves in the field of view.

20. Protective eye gear for selectively blocking regions of intense light from a field of view, the eye gear comprising:
a lens configured to be positioned in front of a user's eye to form a field of view for the user, the lens having a two dimensional array of electronically controllable, variable transparency liquid crystal display elements;
at least one camera located in proximity to the lens, the camera monitoring the images entering the field of view of the user and providing an electrical image signal; and,
a controller coupled to the lens and the camera, the controller receiving the image signal from the camera and determining one or more regions of intense light within the field of view of the user, the controller mapping the regions of intense light received by the camera to the corresponding set of liquid crystal display elements on the lens receiving the intense light, the controller selectively attenuating the transparency of the corresponding set of liquid crystal display elements on the lens receiving the intense light.

21. The protective eye gear for selectively blocking regions of intense light from a field of view of claim 20, wherein the two dimensional array of electronically controllable, variable transparency elements may block the intense light by forming geometrical shapes to cover the regions of intense light.

22. The protective eye gear for selectively blocking regions of intense light from a field of view of claim 20, wherein the controller thresholds and centroids the regions of intense light and translates the coordinates to the lens to attenuate the associated elements.
